(19) United States
(12) Patent Application Publication
(10) Pub. No.: US 2026/0007505 A1
(43) Pub. Date: Jan. 8, 2026

(54) ELECTRIC TOOTHBRUSH

(71) Applicant: Shenzhen Yidian Zhizao Technology Co., Ltd., Shenzhen (CN)

(72) Inventor: Chunmei Peng, Shenzhen (CN)

(21) Appl. No.: 19/256,177

(22) Filed: Jul. 1, 2025

(30) Foreign Application Priority Data
Jul. 2, 2024 (CN) 202410888104.4
Jul. 2, 2024 (CN) 202421549354.7

(51) Int. Cl. A61C 17/22; A46B 5/00; A46B 13/02; A46B 15/00; A61C 17/34; H02J 50/10; H02K 7/14

(52) U.S. Cl. CPC A61C 17/225; A46B 5/0095; A46B 13/023; A46B 15/0004; A61C 17/224; A61C 17/3481; H02J 50/10; H02K 7/14

(57) ABSTRACT

An electric toothbrush, including a handle, a toothbrush head, an output shaft, a coil winding, and a permanent magnet. The handle includes a housing and a partition plate disposed inside the housing, the housing includes an accommodation cavity and a rotation cavity, the accommodation cavity and the rotation cavity are separated by the partition plate, and the partition plate is sealingly connected to the housing. The toothbrush head is arranged outside the handle. The output shaft is rotatably mounted on the handle, the output shaft is connected to the toothbrush head, and the output shaft extends into the rotation cavity. The coil winding is arranged in the accommodation cavity, and the coil winding is electrically connected to a power source. The permanent magnet is disposed at a side of the rotation cavity adjacent to the coil winding, and the permanent magnet is connected to the output shaft.

The present application claims the priority of Chinese patent application No. 202410888104.4, filed on Jul. 2, 2024; Chinese patent application No. 202421549354.7, filed on Jul. 2, 2024, contents of which are incorporated herein by its entirety.

### FIELD

The present disclosure relates to the field of toiletries, and particularly to an electric toothbrush.

### BACKGROUND

The motor serves as a critical component of the electric toothbrush, providing driving force for its operation. In conventional electric toothbrushes, the motor is installed inside the handle, and the output shaft of the motor is connected to the brush head which is arranged outside the handle. During use, the water tends to penetrate along the output shaft into the motor compartment, which can lead to motor failure and consequently reduce the service life of the electric toothbrush.

### SUMMARY

An electric toothbrush, including a handle, a toothbrush head, an output shaft, a coil winding, a permanent magnet. The handle includes a housing and a partition plate disposed inside the housing, the housing includes an accommodation cavity and a rotation cavity, the accommodation cavity and the rotation cavity are separated by the partition plate, and the partition plate is sealingly connected to the housing. The toothbrush head is arranged outside the handle. The output shaft is rotatably mounted on the handle, the output shaft is connected to the toothbrush head, and the output shaft extends into the rotation cavity. The coil winding is arranged in the accommodation cavity, and the coil winding is electrically connected to a power source. The permanent magnet is disposed at a side of the rotation cavity adjacent to the coil winding, the permanent magnet is connected to the output shaft. Since the electric toothbrush utilizes magnetic coupling to drive the output shaft, the output shaft and the coil winding can be physically separated from each other via the partition plate. When external moisture penetrates into the handle interior along the output shaft, the partition plate prevents the moisture from contacting the coil winding.

### BRIEF DESCRIPTION OF THE DRAWINGS

To provide a clearer illustration of the technical solutions in the embodiments of the present disclosure or in the prior art, a brief introduction will be given to the drawings used in the description of the embodiments or the prior art. It is obvious that the drawings described below are merely some embodiments of the present disclosure, and for those skilled in the art, other drawings can be obtained based on these drawings without creative efforts.

FIG. 1 is a schematic diagram showing the overall external appearance of the electric toothbrush according to an embodiment of the present disclosure.

FIG. 2 is an exploded assembly view according to an embodiment of the present disclosure.

FIG. 3 is a cross-sectional view according to an embodiment of the present disclosure.

FIG. 4 is a first partial cross-sectional view according to an embodiment of the present disclosure.

FIG. 5 is a second partial cross-sectional view according to an embodiment of the present disclosure.

FIG. 6 is a cross-sectional view of the housing according to an embodiment of the present disclosure.

FIG. 7 is an exploded assembly view showing the relationship between the end cover, the internal support element, the output shaft, the permanent magnet, and the elastic member according to an embodiment of the present disclosure.

FIG. 8 is a schematic diagram showing the connection structure between the end cover, the internal support element, the output shaft, the permanent magnet, and elastic member according to an embodiment of the present disclosure.

FIG. 9 is a schematic diagram of the elastic member according to an embodiment of the present disclosure.

FIG. 10 is a schematic diagram showing the swinging motion of the permanent magnet according to an embodiment of the present disclosure.

FIG. 11 is a schematic diagram showing the current variation in the coil winding according to an embodiment of the present disclosure.

FIG. 12 is a schematic diagram showing the current variation in the coil winding according to another embodiment of the present disclosure.

FIG. 13 is a schematic diagram showing the current variation in the coil winding according to another embodiment of the present disclosure.

FIG. 14 is a cross-sectional view showing the first housing portion, the second housing portion, and the partition plate according to an embodiment of the present disclosure.

FIG. 15 is a cross-sectional view showing the first housing portion, the second housing portion, and the partition plate according to another embodiment of the present disclosure.

FIG. 16 is a cross-sectional view showing the protrusion structure according to an embodiment of the present disclosure.

Reference numerals in the drawings:

1, handle; 10, mounting cavity; 11, housing; 110, protrusion structure; 111, first housing portion; 112, second housing portion; 12, partition plate; 13, internal support element; 14, end cover; 131, frame; 132, bearing; 101, accommodation cavity; 102, rotation cavity; 1021, opening; 1022, sliding groove; 1301, sliding protrusion; 1311, snap-fit portion; 1312, third connection portion; 2, toothbrush head; 3, output shaft; 31, mounting groove; 4, coil winding; 41, copper coil; 42, iron core; 411, winding group; 421, winding end; 5, permanent magnet; 51, magnetic pole end; 6, control board; 7, battery; 8, charging coil; 9, elastic member; 91, first connection portion; 92, vibration portion; 93, second connection portion; 94, stepped connection portion; 1001, first screw; 1002, second screw.

### DETAILED DESCRIPTION

Unless otherwise defined, all technical and scientific terms used herein have the same meaning as commonly understood by those skilled in the art to which this disclosure belongs. The terms used in the description of the application herein are intended for describing particular embodiments only and are not intended to limit the present disclosure. In the description, claims, and the above drawings of the present disclosure, the terms “comprising” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in connection with an embodiment may be included in at least one embodiment of the present disclosure. The appearance of the phrase at various places in the specification does not necessarily refer to the same embodiment, nor is it a separate or alternative embodiment that is mutually exclusive of other embodiments. One skilled in the art would explicitly and implicitly understand that the embodiments described herein can be combined with other embodiments.

In order to enable those skilled in the art to better understand the technical solutions of the present disclosure, the technical solutions in the embodiments of the present disclosure will be clearly and completely described below with reference to the accompanying drawings.

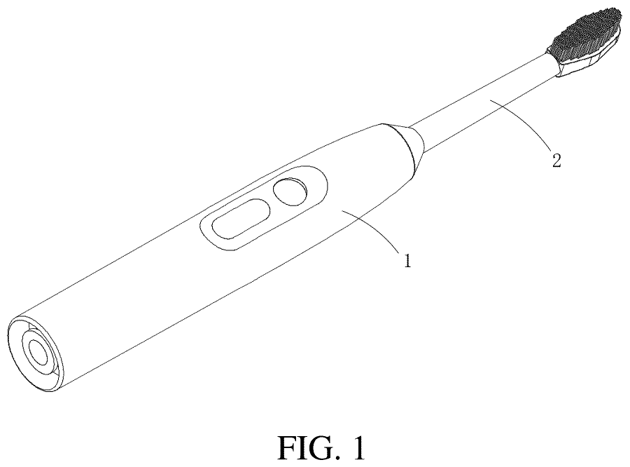

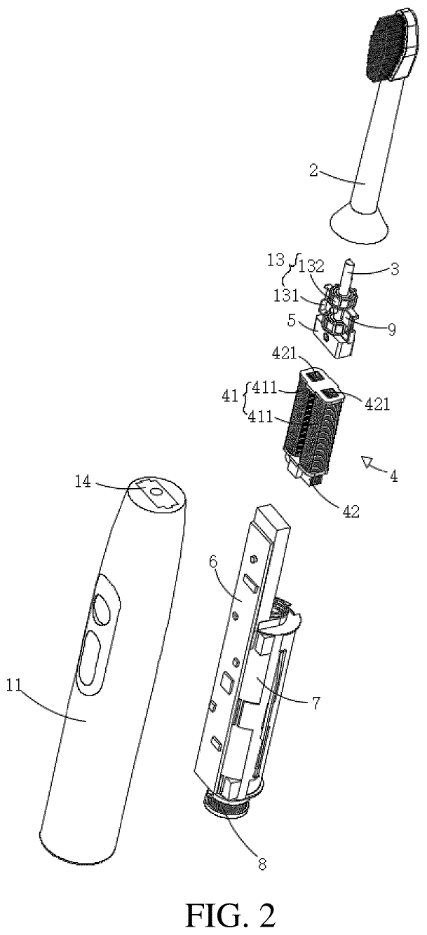

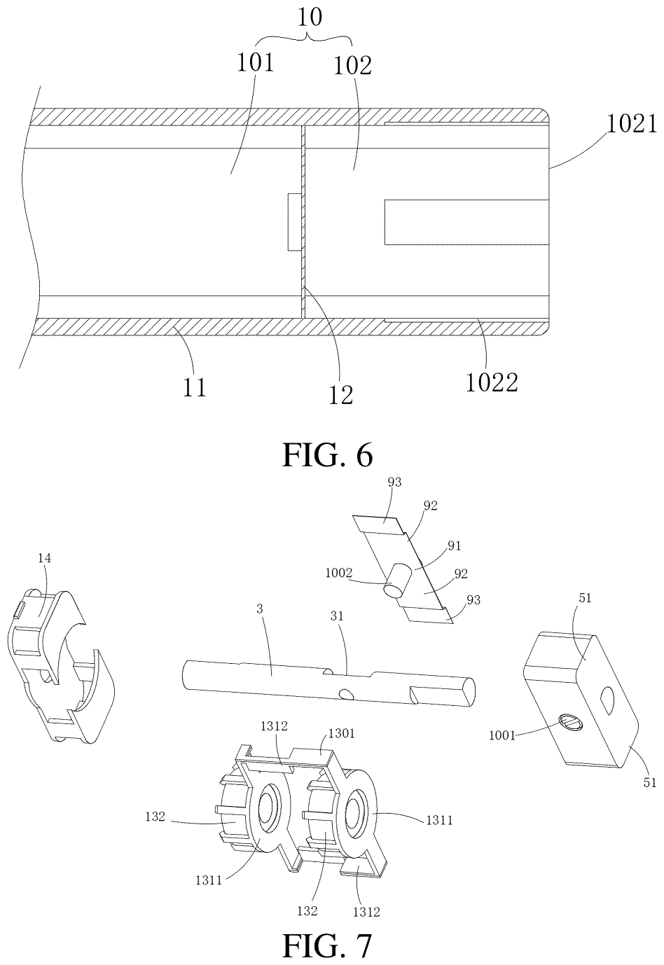

As shown in FIG. 1 to FIG. 16, the present disclosure discloses a magnetically coupled reciprocating rotation motor, including: a handle 1, an output shaft 3, a coil winding 4, a permanent magnet 5, and an elastic member 9.

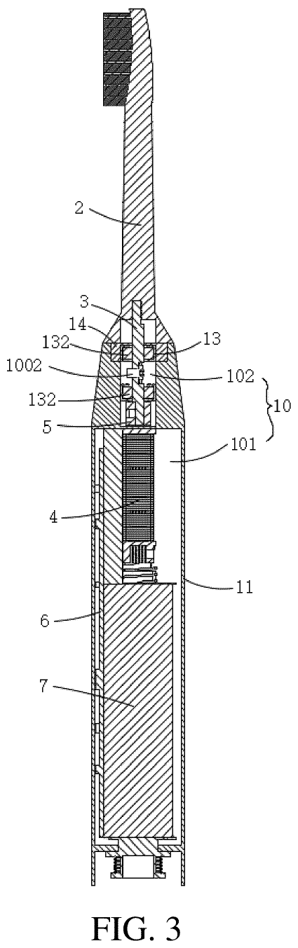

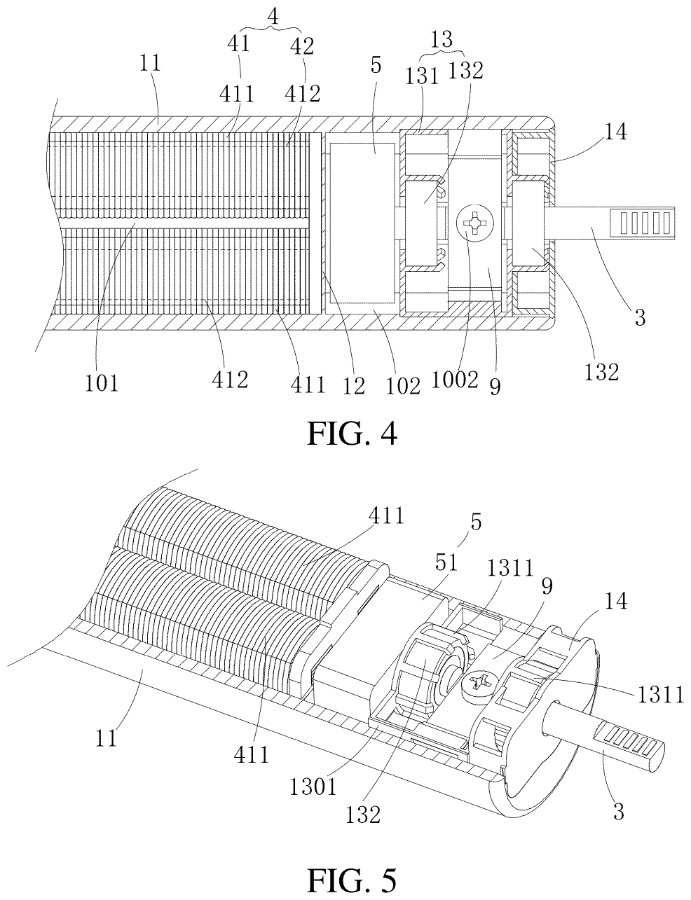

The handle 1 includes a housing 11 and a partition plate 12. A mounting cavity is defined within the housing 11. The partition plate 12 is arranged within the mounting cavity 10 and divides the mounting cavity 10 into an accommodation cavity 101 and a rotation cavity 102. The rotation cavity 102 has an opening 1021 at a side away from the partition plate 12. A toothbrush head 2, made of plastic material, is arranged on an outer side of the handle 1. An end portion of the housing 11 can be formed into different shapes as needed, such as those shown in FIG. 3 and FIG. 4. The output shaft 3 is rotatably mounted on the handle 1. The output shaft 3 is connected to the toothbrush head 2 by interference fit or threaded connection. The output shaft 3 extends into the rotation cavity 102 through the opening 1021. The coil winding 4 includes a copper coil 41 and an iron core 42. The copper coil 41 is connected to a power source. The copper coil 41 includes two winding groups 411 electrically connected to each other, namely a first winding group and a second winding group. The iron core 42 includes two winding ends 421 symmetrically arranged with each other, namely the first winding end and the second winding end. The first winding group is wound on the first winding end, and the second winding group is wound on the second winding end. When the copper coil 41 is energized, opposite magnetic polarities are generated by the two winding groups 411.

The permanent magnet 5 can be arranged inside the rotation cavity 102 through the opening 1021, and the permanent magnet 5 is fixed to the output shaft 3. The output shaft 3 can only rotate in a circumferential direction, and the output shaft 3 can be driven to swing in response to a reciprocating oscillation of the permanent magnet 5. Specifically, the permanent magnet 5 includes two magnetic pole ends 51, namely a first magnetic pole end and a second magnetic pole end. The first magnetic pole end and the second magnetic pole end have opposite polarities. The permanent magnet 5 is positioned at a side of the rotation cavity adjacent to the coil winding 4 to enable magnetic coupling. To be specific, the first magnetic pole end is positioned adjacent to the first winding group, and the second magnetic pole end is positioned adjacent to the second winding group.

When a forward current is supplied to the copper coil 41, the first winding group 411 generates a magnetic polarity that is the same as that of the first magnetic pole end 51. Meanwhile, the second winding group 411 generates a magnetic polarity that is the same as that of the second magnetic pole end 51, such that the first magnetic pole end is repelled and moves away from the first winding group, and the second magnetic pole end is repelled and moves away from the second winding group. Conversely, when a reverse current is supplied to the copper coil 41, the first winding group 411 generates a magnetic polarity opposite to that of the first magnetic pole end 51. At the same time, the second winding group 411 generates a magnetic polarity opposite to that of the second magnetic pole end 51, such that the first magnetic pole end 51 is attracted and moves closer to the first winding group 411, and the second magnetic pole end 51 is attracted and moves closer to the second winding group 411. The output shaft 3 is driven to rotate based on aforementioned principle. In other words, the output shaft 3 does not need to be in contact with the coil winding 4, such that the partition plate 12, though located between the output shaft 3 and the coil winding 4, does not hinder the rotation of the output shaft 3. In the present application, the partition plate 12 is sealingly connected to the housing 11. Therefore, when external moisture penetrates into the handle 1 along the output shaft 3, the partition plate 12 prevents the moisture from coming into contact with the coil winding 4. That is, the partition plate 12 prevents a powered coil winding 4 from being damaged by water.

As shown in FIG. 4, in an embodiment, the housing 11 and the partition plate 12 are configured as an integral structure, which means the housing 11 does not need to be divided into two parts for installation. Therefore, there is no installation gap on an outer side wall of the housing 11. As a result, external moisture cannot bypass the partition plate 12 through an installation gap to enter the accommodation cavity 101, such that the accommodation cavity 101 can be protected from penetration by external moisture.

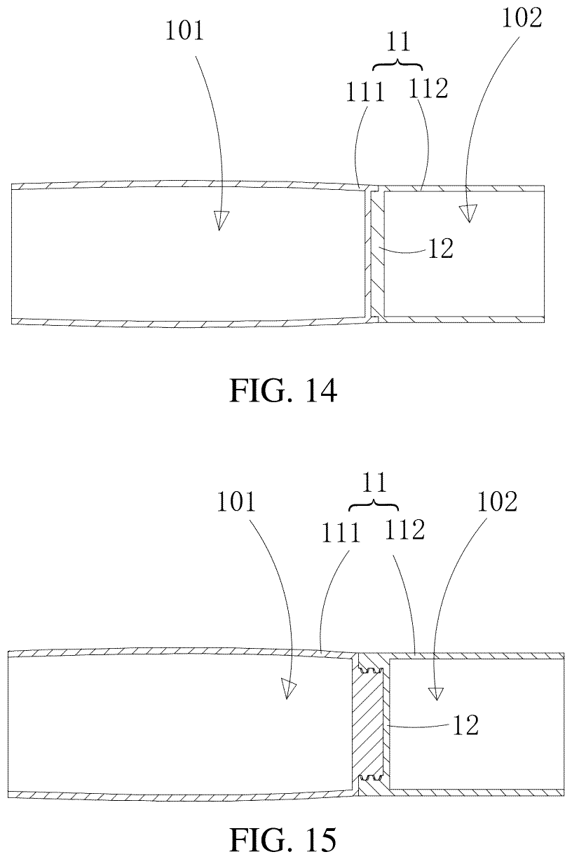

In some embodiments, as shown in FIG. 14 and FIG. 15, the housing 11 includes a first housing portion 111 and a second housing portion 112. The partition plate 12 may be formed either within the first housing portion 111, within the second housing portion 112, or within both the first housing portion 111 and the second housing portion 112. The first housing and the second housing may be connected with each other through threaded connections or adhesive bonding.

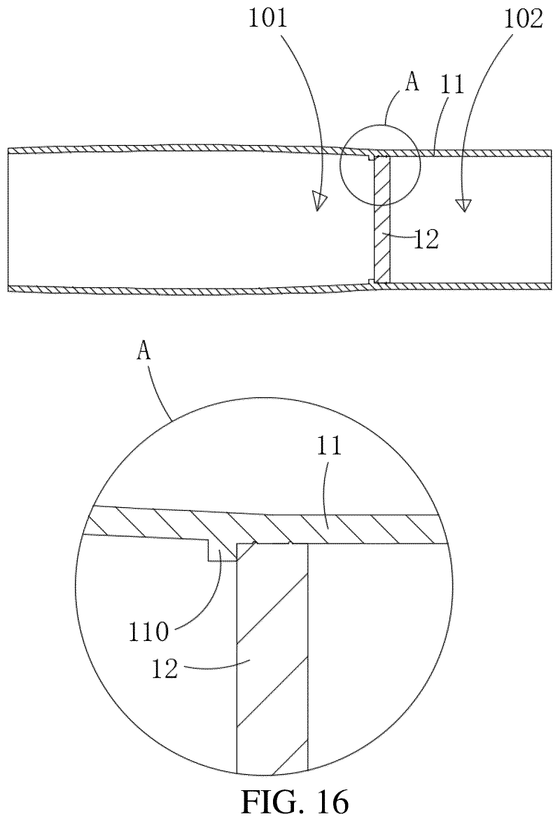

The housing 11 and the partition plate 12 can also be two separate structures, and waterproof sealing between the partition plate 12 and the housing 11 can be achieved by a sealing ring or sealing adhesive. For example, in an embodiment, as shown in FIG. 16, a protrusion structure 110 is formed on an inner wall of the housing 11, and the partition plate 12 is mounted on the protrusion structure 110 and separates the mounting cavity 10 into the accommodation cavity 101 and the rotation cavity 102. A sealed connection between the partition plate 12 and the housing 11 can be achieved by injecting sealant or by setting a sealing ring between the partition 12 and the housing 11. For example, in an embodiment, an annular sealing groove is defined in the partition plate 12, the sealing ring is embedded in the sealing groove, and the inner wall of the housing 11 includes a sealing compression surface. When the partition plate 12 is installed in the housing 11, the sealing ring is compressed between the sealing groove and the sealing compression surface to form a radial seal. In another embodiment, an outer edge of the partition plate 12 has an external thread, and the inner wall of the housing 11 has an internal thread, the partition plate 12 can be threaded and secured to the housing 11 through the external thread and the internal thread, and sealing adhesive can be applied to thread engagement surfaces to achieve a sealed connection between the partition plate 12 and the housing 11. Thus, when external moisture penetrates into the interior of the handle 1 along the output shaft 3, the sealing ring 15 can block the moisture from entering the accommodation cavity 101.

In an embodiment, the electric toothbrush includes a control board 6, a battery 7, and a wireless charging coil 8. The control board 6, the battery 7, and the wireless charging coil 8 are all disposed within the accommodation cavity 101, and the wireless charging coil 8 is located on a side of the accommodation cavity 101 away from the rotation cavity 102. The control board 6 is electrically connected to the coil winding 4, and the control board 6 controls electrical signal input to the coil winding 4. The battery 7 is electrically connected to the control board 6 and is configured to supply power to the control board 6 and the coil winding 4. The wireless charging coil 8 is electrically connected to the battery 7 and configured to cooperate with a wireless charger to generate current through electromagnetic induction, thereby charging the battery 7.

In order to reduce energy consumption of the coil winding 4, with reference to FIGS. 4, 5, 7, 8, and 9, the electric toothbrush in this embodiment also includes an elastic member 9. The elastic member 9 is arranged within the rotation cavity 102 and includes a first connection portion 91 and a vibration portion 92, the first connection portion 91 and the vibration portion 92 are integrally formed as a one-piece structure. The first connection portion 91 is fixedly mounted on the output shaft 3. The vibration portion 92 extends in a direction perpendicular to an axial direction of the output shaft 3, and an end of the vibration portion 92 that is away from the first connection portion 91 is connected to the handle 1. When the output shaft 3 rotates in a forward direction, the elastic member 9 undergoes a forward elastic deformation. If the current input to the copper coil 41 is stopped at this moment, the elastic member 9 releases stored elastic potential energy, causing a rapid reverse motion and generating a reverse elastic deformation with a reduced amplitude. This reverse elastic deformation subsequently releases potential elastic energy again, resulting in a forward deformation with further reduced amplitude. This process continues, with the amplitude gradually decreasing, until the elastic potential energy of the elastic member 9 is fully dissipated and the elastic member 9 returns to an original position. During this process, the elastic member 9 performs a reciprocating vibration. The motor can utilize the reciprocating vibration of the elastic member 9 to provide additional driving force for a reciprocating motion of the output shaft 3. As a result, electrical energy input to the copper coil 41 only needs to ensure that a vibration amplitude of each cycle of the elastic member 9 remains consistent or nearly consistent. In this way, working energy of the current is significantly reduced, resulting in lower energy consumption. In addition, the deformation of the elastic member 9 mainly occurs at the vibration portion 92. In an embodiment, the vibration portion 92 extends linearly in the direction perpendicular to the axial direction of the output shaft 3. In this way, each vibration can be directly transmitted from one end of the vibration portion 92 to the other end of the vibration portion 92, which reduces influence of residual vibration on the vibration portion 92. As a result, it becomes easier to adjust the vibration amplitude of the vibration portion 92, such that a vibration frequency of the vibration portion 92 can be more easily matched with a rotation cycle of the output shaft 3.

An initial position of the permanent magnet 5 is defined as a position in which a center line between the two magnetic pole ends 51 is parallel to a center line between the two winding groups 411.

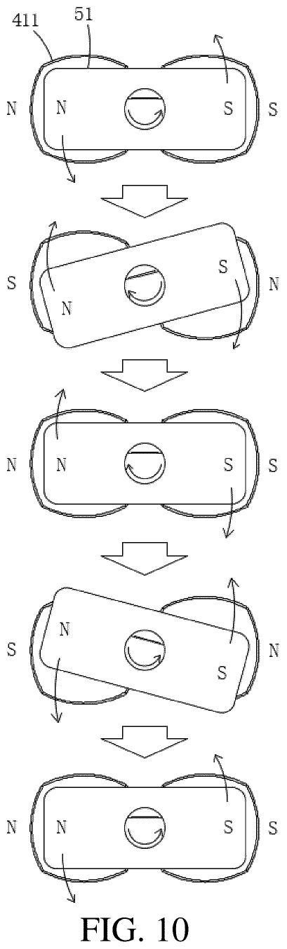

As shown in FIG. 10, when the forward current is supplied to the copper coil 41, each of the winding groups 411 generates a magnetic field that is identical in polarity to the corresponding magnetic pole end 51. As a result, the first magnetic pole end is repelled away from the first winding group, and the second magnetic pole end is repelled away from the second winding group, such that the permanent magnet 5 rotates in the forward direction away from the winding groups 411, driving the output shaft 3 to rotate forward. During this process, the elastic member 9 is elastically deformed and stores elastic potential energy. When a repulsive torque generated by the winding groups 411 on the magnetic pole ends 51 becomes equal to an elastic torque generated by the elastic member 9 on the output shaft 3, an angular acceleration of the output shaft 3 becomes zero. Subsequently, when the reverse current is supplied to the copper coil 41, each of the winding groups 411 generates a magnetic field that is opposite in polarity to the corresponding magnetic pole end 51. As a result, the first magnetic pole end is attracted by the first winding group, and the second magnetic pole end is attracted by the second winding group, such that the permanent magnet 5 rotates in a reverse direction, driving the output shaft 3 to rotate in the reverse direction. During this process, the elastic member 9 releases the stored elastic potential energy, which assists a reverse rotation of the output shaft 3 and a reverse swinging of the magnetic pole ends 51, and the permanent magnet 5 can be driven to return to the initial position.

When the permanent magnet 5 returns to the initial position, the forward current is supplied to the copper coil 41 again, causing the winding groups 411 to generate repulsive forces against the magnetic pole ends 51. Under a combined action of the repulsive forces and motion inertia, the magnetic pole ends 51 can pass over the initial position, driving the output shaft 3 to continually rotate in the reverse direction, simultaneously causing the elastic member 9 to elastically deform in an opposite direction. When the repulsive torque generated by the winding groups 411 on the magnetic pole ends 51 equals the elastic torque generated by the elastic member 9, the angular acceleration of the output shaft 3 during reverse rotation reaches zero. Subsequently, when reverse current is supplied to the copper coil 41 again, the winding groups 411 generate attractive forces on the magnetic pole ends 51, and the elastic member 9 simultaneously releases the stored elastic potential energy. Under a combined action of the attractive forces from the winding groups 411 and an elastic force from the elastic member 9, the magnetic pole ends 51 rotate forward, driving the output shaft 3 to rotate forward. This continues until the permanent magnet 5 returns to the initial position, at which point one complete motion cycle is finished.

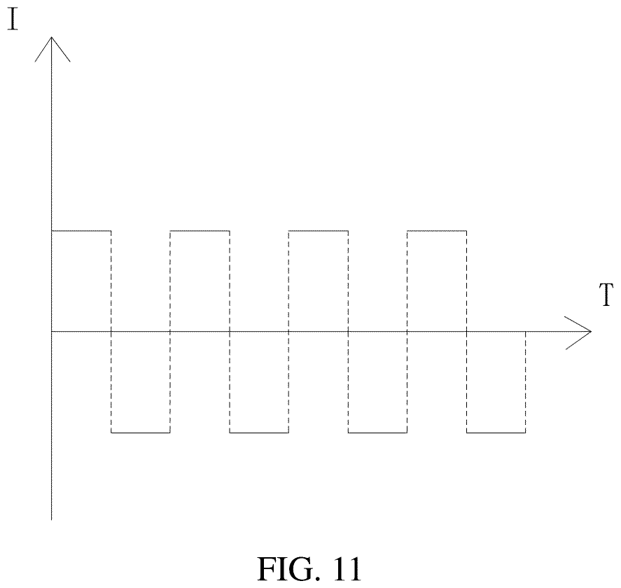

In the present embodiment, transitions between forward and reverse currents are illustrated in FIG. 11, where T represents a current application duration and I represents a current intensity.

It should be noted that, the forward and reverse rotations of the output shaft 3 represent two distinct rotational directions only, and the forward and reverse currents represent two opposing current input directions only.

In the magnetically coupled reciprocating motor, the vibration portion 92 has a short length and brief vibration duration, which facilitates adjustment of reciprocation frequency of the output shaft 3, minimizing residual vibration interference. Furthermore, by adjusting the duration of the forward current and the reverse current application, when the reciprocation frequency of the output shaft 3 approaches or matches the vibration frequency of the vibration portion 92, the elastic member 9 provides greater energy transfer during reciprocating rotation of the output shaft 3, such that current required by the coil winding 4 can be significantly reduced, and power consumption of the magnetically coupled reciprocating motor can be substantially lowered.

Magnetic forces generated by the winding groups 411 can be adjusted by changing a current magnitude in the coil winding 4. When maintaining constant current application duration, changing the current magnitude can adjust a maximum rotation angle of the output shaft 3. The reciprocation frequency of the output shaft 3 can be changed by modifying a frequency of switching the current direction in the coil winding 4. That is, changing a working duration of the current in each direction can adjust the reciprocation frequency of the output shaft 3. In addition, the elastic member 9 can be provided with different elastic strength according to different application requirements. The elastic strength of the elastic member 9 may be adjusted by modifying at least one of thickness, width, or length.

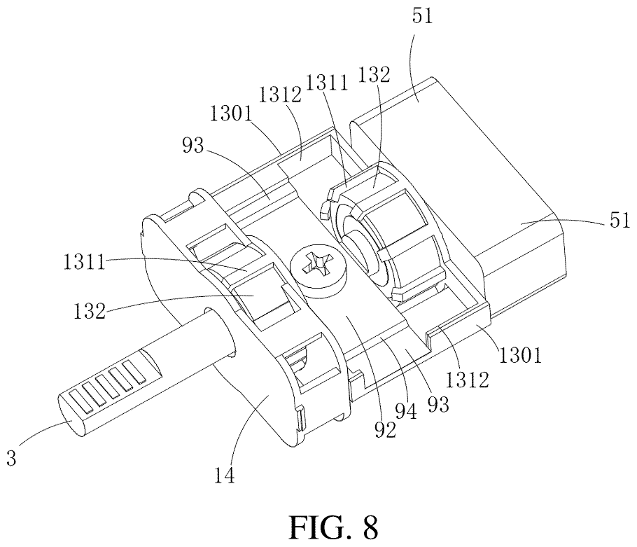

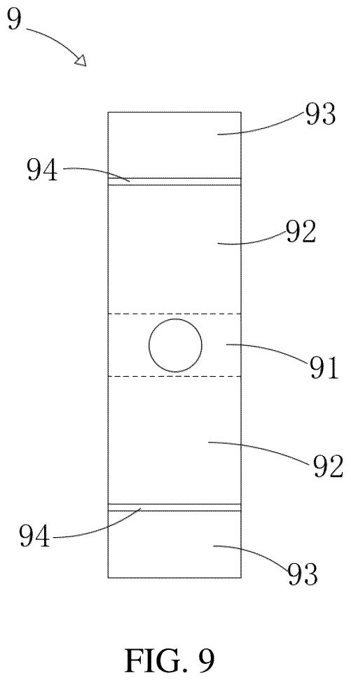

In an embodiment, to facilitate manufacturers in adjusting the elastic strength of the elastic member 9 according to different motor sizes, a length of the vibration portion 92 can be adjusted. As shown in FIG. 8 and FIG. 9, the elastic member includes a second connection portion 93, the first connection portion 91 and the vibration portion 92 collectively form a plate structure, the second connection portion 93 is connected to a side of the vibration portion 92 away from the first connection portion 91 through a stepped connection portion 94, and the second connection portion 93 is connected to the handle 1. In some embodiments, the first connection portion 91, the vibration portion 92, and the second connection portion 93 are formed as an integral structure, and the stepped connection portion 94 is formed between the vibration portion 92 and the second connection portion 93, the stepped connection portion effectively suppresses vibration transmission, reducing vibration transfer from the vibration portion 92 to the second connection portion 93, such that the deformation of the elastic member 9 can mainly occur at the vibration portion 92 rather than the second connection portion 93. It should be noted that the above adjustment is applicable only when the length of the vibration portion 92 is greater than that of the second connection portion 93. The manufacturers can adjust the position of the stepped connection portion 94 to change the length of the vibration portion 92, such that a maximum elastic force provided by the vibration portion 92 can be adjusted.

In an embodiment, a mounting groove 31 is defined on the output shaft 3, the first connection portion 91 extends through a groove wall of the mounting groove 31, and a part of the first connection portion 91 where the first connection portion 91 connects the output shaft 3 coincides with an axis of the output shaft 3. In this way, the elastic force from the vibration portion 92 can act along the axis of output shaft 3, and radial shear forces on output shaft 3 can be reduced. In some embodiments, the elastic member 9 has two vibration portions 92 and two second connection portions 93, the two vibration portions 92 are centrally symmetrized about the axis of the output shaft 3, and two second connection portions 93 are centrally symmetrized about the axis of the output shaft 3, in this way, a total elastic force provided by the elastic member 9 can be increased.

In an embodiment, as shown in FIG. 4 to FIG. 8, the handle 1 includes an internal support element 13 and an end cover 14.

The internal support element 13 is mounted within the rotation cavity 102, the vibration portion 92 is connected to the internal support element 13, and the permanent magnet 5 is positioned between the partition plate 12 and the internal support element 13. The end cover 14 is mounted at the opening 1021 of the rotation cavity 102 to abut against the internal support element 13. The output shaft 3 sequentially extends through the end cover 14 and the internal support element 13 to connect to the permanent magnet 5. A sliding groove 1022 is defined in an inner wall of the rotation cavity 102, the sliding groove 1022 extends along a direction parallel to an axial direction of the output shaft 3, and the sliding groove 1022 is communicated with the opening 1021. A sliding protrusion 1301 is arranged on the internal support element 13, and the sliding protrusion 1301 extends into the sliding groove 1022 and abuts against an end surface of the sliding groove 1022 adjacent to the partition plate 12. In this way, the internal support element 13 can be prevented from rotating with the output shaft 3.

In the present embodiment, the internal support element 13 facilitates installation of both the elastic member 9 and the permanent magnet 5. The specific assembly procedure includes following operations.

In an operation 1, the output shaft 3 is inserted through the internal support element 13.

In an operation 2, the elastic member 9 is connected to both the output shaft 3 and the internal support element 13.

In an operation 3, the permanent magnet 5 is mounted onto the output shaft 3.

In an operation 4, the internal support element 13 is positioned adjacent to the opening 1021, and the sliding protrusion 1301 is aligned with the sliding groove 1022, then the internal support element 13 is pushed into the rotation cavity 102 along the sliding groove 1022.

In an operation 5, the end cover 14 is mounted at the opening 1021, securing the end cover 14 against the internal support element 13.

To further reduce rotational friction losses of the output shaft 3, in an embodiment, the internal support element 13 includes a frame 131 and a bearing 132. The second connection portion 93 is fixedly connected to the frame 131 through press-fitting, screw fastening, or other manners. The bearing 132 is mounted on the frame 131 and sleeved on the output shaft 3, such that the rotational friction losses between the output shaft 3 and the handle 1 can be reduced.

In an embodiment, the frame 131 includes two snap-fit portions 1311 and a third connection portion 1312, the third connection portion 1312 connects the two snap-fit portions 1311, and the sliding protrusion 1301 is arranged on the third connection portion 1312. In this embodiment, the internal support element 13 includes two bearings 132, as shown in FIG. 7 and FIG. 8, each bearing 132 is snap-engaged with one of the two snap-fit portions 1311, the second connection portion 93 is connected to the third connection portion 1312, and the elastic member 9 is disposed between the two snap-fit portions 1311. The two bearings 132 serve to enhance supporting capacity for the output shaft 3, preventing radial vibration and deviation of the output shaft 3, such that stability of the motor can be improved, and service life of the motor can be extended.

The magnetically coupled reciprocating motor further includes a first screw 1001 and a second screw 1002. The permanent magnet 5 is secured to the output shaft 3 through the first screw 1001, and the first connection portion 91 is fastened to the output shaft 3 through the second screw 1002. In other embodiments, the permanent magnet 5 or the elastic member 9 can be secured onto the output shaft 3 via pins, welding, or other fastening methods.

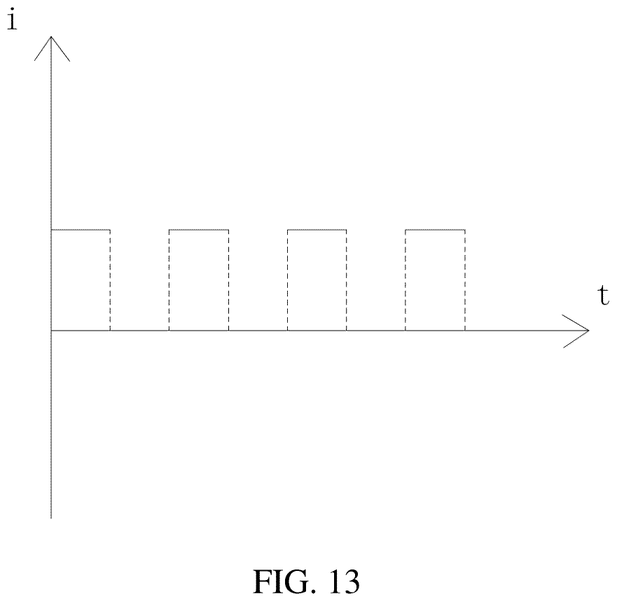

In another embodiment, the copper coil 41 may be energized with unidirectional current only, the current variation of which is illustrated in FIG. 13, where t represents the current application duration, and i represents the current intensity.

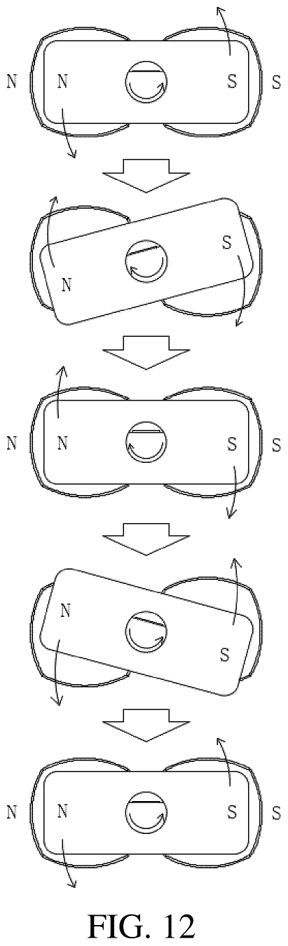

As shown in FIG. 12, when the unidirectional current is applied to the copper coil 41, each winding group 411 generates the magnetic field with the same polarity as the corresponding magnetic pole end 51, causing the magnetic pole ends 51 to be repelled away from the winding groups 411. In this way, the output shaft 3 can be driven to rotate forward, during this process, the elastic member 9 is elastically deformed and stores elastic potential energy. When the repulsive torque generated by the winding groups 411 on the magnetic pole ends 51 becomes equal to an elastic torque generated by the elastic member 9 on the output shaft 3, the angular acceleration of the output shaft 3 becomes zero. After stopping application of the unidirectional current, the elastic member 9 releases the stored elastic potential energy, which assists the reverse rotation of the output shaft 3 and the reverse swinging of the magnetic pole ends 51, driving the permanent magnet 5 to return to the initial position.

When the permanent magnet 5 returns to the initial position, the unidirectional current is supplied to the copper coil 41 again, causing the winding groups 411 to generate repulsive forces against the magnetic pole ends 51. Under the combined action of the repulsive forces and motion inertia, the magnetic pole ends 51 can pass over the initial position, driving the output shaft 3 to continually rotate in the reverse direction, simultaneously causing the elastic member 9 to elastically deform in the opposite direction. When the repulsive torque generated by the winding groups 411 on the magnetic pole ends 51 equals the elastic torque generated by the elastic member 9, the angular acceleration of the output shaft 3 during reverse rotation reaches zero. And the application of the unidirectional current is stopped again, the elastic member 9 releases the stored elastic potential energy, driving the output shaft 3 to rotate forward, that is, the magnetic pole ends 51 are driven to rotate forward. This continues until the permanent magnet 5 returns to the initial position, at which point one complete motion cycle is finished.

Compared with the previous embodiment, the direction of the current does not need to be changed in this embodiment, an overall working time of the current can be reduced, and the power consumption of the motor can be decreased. However, the elastic member 9 should meet higher standards for both elastic strength and quality in this embodiment.

Obviously, the embodiments described above are only a part of the embodiments of the present disclosure, and not all of them. The accompanying drawings give some embodiments of the present disclosure, but do not limit the patentable scope of the disclosure, which may be realized in many different forms. Rather, these embodiments are provided for the purpose of providing a more thorough and comprehensive understanding of the present disclosure. Although the present disclosure has been described in detail with reference to the foregoing embodiments, it is still possible for a person skilled in the art to modify the technical solutions recorded in the foregoing specific embodiments or to make equivalent substitutions for some of the technical features therein. Any equivalent structure made by utilizing the contents of the specification and the accompanying drawings of the present disclosure, directly or indirectly applied in other related technical fields, are all the same within the scope of the patent protection of the present disclosure.

What is claimed is:

1. An electric toothbrush, comprising:
a handle, wherein the handle comprises a housing and a partition plate disposed inside the housing, the housing comprises an accommodation cavity and a rotation cavity, the accommodation cavity and the rotation cavity are separated by the partition plate, and the partition plate is sealingly connected to the housing;
a toothbrush head, wherein the toothbrush head is arranged on an outer side of the handle;
an output shaft, wherein the output shaft is rotatably mounted on the handle, the output shaft is connected to the toothbrush head, and the output shaft extends into the rotation cavity;
a coil winding, wherein the coil winding is arranged in the accommodation cavity, and the coil winding is electrically connected to a power source;
a permanent magnet, wherein the permanent magnet is disposed at a side of the rotation cavity adjacent to the coil winding, the permanent magnet is connected to the output shaft.

2. The electric toothbrush according to claim 1, wherein the partition plate and the housing are configured as an integral and one-piece structure.

3. The electric toothbrush according to claim 1, wherein the coil winding comprises a copper coil and an iron core, the copper coil is electrically connected to the power source, the copper coil comprises a first winding group and a second winding group, the iron core comprises a first winding end and a second winding end symmetrically arranged with the first winding end, the first winding group is wound on the first winding end, and the second winding group is wound on the second winding end;
wherein when the copper coil is energized, the first winding group and the second winding group generate opposite magnetic polarities;
wherein the permanent magnet comprises a first magnetic pole end and a second magnetic pole end, the first magnetic pole end and the second magnetic pole end have opposite polarities, the first magnetic pole end is positioned adjacent to the first winding group, the second magnetic pole end is positioned adjacent to the second winding group.

4. The electric toothbrush according to claim 1, wherein the output shaft is connected to the toothbrush head by insertion/plugging connection or threaded connection.

5. The electric toothbrush according to claim 1, further comprising a control board, a battery, and a wireless charging coil, wherein the control board, the battery, and the wireless charging coil are arranged within the accommodation cavity, wherein the wireless charging coil is located at a side of the accommodation cavity away from the rotation cavity;
wherein the control board is electrically connected to the coil winding;
wherein the battery is electrically connected to the control board;
wherein the wireless charging coil is electrically connected to the battery.

6. The electric toothbrush according to claim 1, wherein the rotation cavity has an opening at a side away from the partition plate, the handle further comprises:
a frame mounted within the rotation cavity, wherein the permanent magnet is positioned between the partition and the frame;
at least one bearing mounted on the frame and sleeved on the output shaft, wherein the output shaft extends through the frame; and
an end cover mounted at the opening of the rotation cavity and connected to the frame, wherein the output shaft extends through the end cover.

7. The electric toothbrush according to claim 6, wherein a sliding groove is defined in an inner wall of the rotation cavity, the sliding groove is parallel to an axial direction of the output shaft and extends to communicate with the opening, a sliding protrusion is disposed on the frame, and the sliding protrusion extends into the sliding groove.

8. The electric toothbrush according to claim 6, wherein the handle comprises two bearings, both the two bearings are mounted on the frame and sleeved on the output shaft; a spacing between the two bearings is greater than half of a length of the rotation cavity.

9. The electric toothbrush according to claim 1, further comprising an elastic member, wherein the elastic member is arranged within the rotation cavity, the elastic member comprises a first connection portion and at least one vibration portion, the first connection portion is mounted on the output shaft, the at least one vibration portion extends in a direction perpendicular to an axial direction of the output shaft, and the at least one vibration portion is connected to the handle.

10. The electric toothbrush according to claim 9, wherein the at least one vibration portion extends linearly in the direction perpendicular to the axial direction of the output shaft.

11. The electric toothbrush according to claim 9,
wherein the elastic member comprises at least one second connection portion, the first connection portion and the at least one vibration portion collectively form a plate structure;
wherein the elastic member further comprises at least one stepped connection portion, and each second connection portion is connected to a side of the at least one vibration portion away from the first connection portion through one of the at least one stepped connection portion, the at least one second connection portion is connected to the handle, and the at least one vibration portion is connected to the handle through the at least one second connection portion.

12. The electric toothbrush according to claim 11, wherein a mounting groove is defined on the output shaft, the first connection portion extends through a groove wall of the mounting groove, and a part of the first connection portion where the first connection portion connects the output shaft coincides with an axis of the output shaft;
wherein the number of the at least one vibration portion is two, and the number of the at least one second connection portion is two, two vibration portions are centrally symmetrized about the axis of the output shaft, and two second connection portions are centrally symmetrized about the axis of the output shaft.
